(19) United States
(12) Patent Application Publication
(10) Pub. No.: US 2019/0383693 A1
(43) Pub. Date: Dec. 19, 2019

(54) PLUMBING MONITORING SYSTEM

(71) Applicant: Gentex Corporation, Zeeland, MI (US)

(72) Inventor: William L. Tonar, Holland, MI (US)

(73) Assignee: Gentex Corporation, Zeeland, MI (US)

(21) Appl. No.: 16/438,808

(22) Filed: Jun. 12, 2019

Related U.S. Application Data
(60) Provisional application No. 62/684,445, filed on Jun. 13, 2018.

(51) Int. Cl. G01M 3/28; F03B 13/10

(52) U.S. Cl. CPC G01M 3/2807; F03B 13/10; F05B 2260/42; F05B 2220/32; F05B 2210/11

(57) ABSTRACT

A plumbing monitoring system includes a detector configured to be coupled to a fluid system, a power section configured to be in electrical communication with the detector, the power section including a turbine configured to move under force from a movement of fluid of the fluid system and a generator coupled to the turbine and configured to generate electrical energy from the movement of the turbine. An electrical storage is in electrical communication with and configured to provide electrical power to the detector.

### CROSS REFERENCE TO RELATED APPLICATIONS

This application claims the benefit of and priority to U.S. Provisional Patent Application No. 62/684,445, filed on Jun. 13, 2018, entitled Plumbing Monitoring System, the entire disclosure of which is hereby incorporated herein by reference.

### FIELD OF THE DISCLOSURE

The present disclosure generally relates to monitoring systems, and more specifically to plumbing monitoring systems.

### BACKGROUND OF THE DISCLOSURE

Systems that monitor fluid lines for malfunctions and leaks may utilize electrical power to do so. In the event of a power failure, a monitoring system that relies on electrical power may not be operative. In situations where the systems may be positioned away from electrical power sources, batteries may be utilized to provide electrical energy. As the systems which monitor the fluid line may not frequently be used, replacement of the batteries may not occur before a malfunction in the fluid system arises. As such, a malfunction in the fluid system may go unnoticed despite the use of the monitoring system.

### SUMMARY OF THE DISCLOSURE

According to at least one aspect of the present disclosure, a plumbing monitoring system may comprise: a detector configured to be coupled to a fluid system; a power section configured to be in electrical communication with the detector, the power section comprising: a turbine configured to move under force from a movement of fluid of the fluid system; and a generator coupled to the turbine and configured to generate electrical energy from the movement of the turbine; and an electrical storage in electrical communication with and configured to provide electrical power to the detector.

The electrical storage may be rechargeable. The generator may be electrically coupled to the electrical storage. The detector may be a fluid level detector. The plumbing monitoring system further may comprise: a transmitter configured to transmit a signal from the detector. The transmitter may be a wireless transmitter. The transmitter may be configured to emit the signal while the turbine may be moving. The electrical storage may be electrically coupled to the transmitter. The detector may be a temperature sensor. The fluid in the plumbing monitoring system may be water. The fluid system may be a plumbing system.

According to at least a second aspect of the present disclosure, a plumbing monitoring system, may comprise: a detector configured to be coupled to a fluid system may comprise; and a power section configured to be coupled to the fluid system, may comprise: a turbine configured to move under force from the fluid of the fluid system; and a generator coupled to the turbine and configured to generate electrical energy from the moving turbine.

According to at least another aspect of the present disclosure, a method for detecting leaks in a plumbing system, may comprise: moving a turbine under force from fluid movement within the plumbing system; generating electric power with a generator in communication with the turbine; transmitting power to at least one of a detector, a transmitter, and an electrical storage; and storing power in the electrical storage.

The method further may comprise transmitting, by the transmitter, information on fluid movement. The information on fluid movement may be transmitted to at least one of a home automation system and an external receiver. The electrical storage may be rechargeable. The fluid detector may be a fluid level detector. The fluid detector may be a sensor configured to detect at least one property of the fluid in the plumbing system. The fluid detector may be a temperature sensor. The electrical storage may be in electrical communication with at least one of the detector, the transmitter, and the electrical storage.

These and other features, advantages, and objects of the present disclosure will be further understood and appreciated by those skilled in the art by reference to the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 is a schematic view a plumbing monitoring system coupled with a fluid system;

FIG. 2 is a cross-sectional view taken at line II-II of FIG. 1; and

FIG. 3 is a flowchart illustrating a method of detecting leaks in a plumbing system.

### DETAILED DESCRIPTION

Additional features and advantages of the invention will be set forth in the detailed description which follows and will be apparent to those skilled in the art from the description, or recognized by practicing the invention as described in the following description, together with the claims and appended drawings.

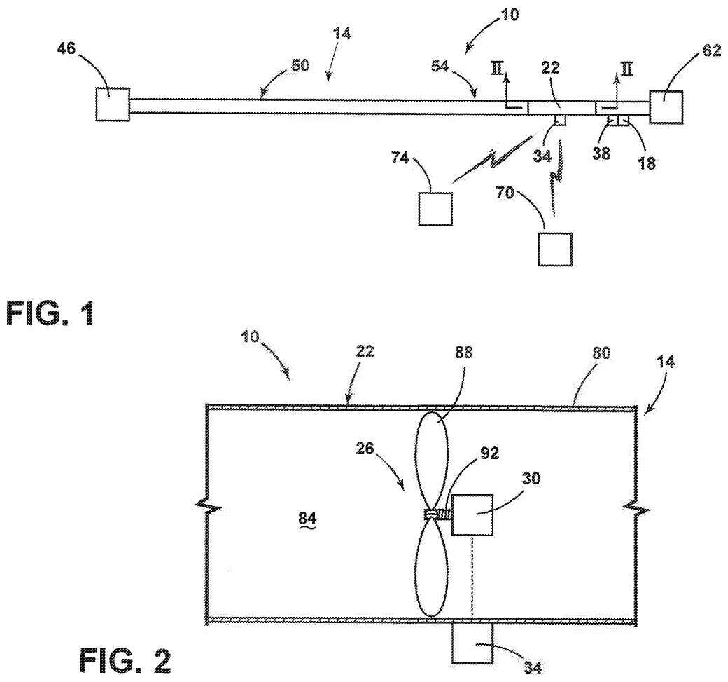

Referring now to FIGS. 1 and 2, depicted is a plumbing monitoring system 10 configured to be used in operation with a fluid system 14 configured to carry a fluid. The plumbing monitoring system 10 includes a detector 18 configured to be coupled to the fluid system 14. A power section 22 of the plumbing monitoring system 10 is configured to be coupled to the fluid system 14. The power section 22 includes a turbine 26 configured to move under force from the fluid of the fluid system 14. The power section 22 also includes a generator 30 coupled to the turbine 26 and configured to generate electrical energy from the moving turbine 26. The plumbing monitoring system 10 may also include an electrical storage 34 electrically coupled with the detector 18. As will be explained in greater detail below, the power section 22 of the plumbing monitoring system 10 may be configured to generate power from fluid moving in the fluid system 14 and provide it to the detector 18, the electrical storage 34 and/or a transmitter 38.

The fluid system 14 is configured to transfer or convey one or more fluids therethrough.

For example, the fluid system 14 may be configured to convey a liquid or a gas. According to various examples, the fluid carried by the fluid system 14 is water. According to various examples, the fluid system 14 may be a home or commercial plumbing system.

The fluid system 14 may include a fluid source 46, a main line 50 and one or more branches 54. The fluid source 46 may be fluidly coupled with the main line 50 and may be configured to supply the fluid from exterior to the fluid system 14 to the main line 50 of the fluid system 14. In home or commercial plumbing examples of the fluid system 14, the fluid source 46 may be the entry point of a municipal or other source of water to a building. The main line 50 in turn supplies the fluid to one or more branches 54. In the depicted example, the fluid system 14 includes a single branch 54 but it will be understood that the fluid system 14 may include more than one branches 54. The branch 54 may terminate at an outlet 62. It will be understood that use of the term “branch” as used herein is intended to encompass any part of the fluid system 14. In a fluid system 14 having only a single branch 54, the branch 54 may coincide with the main line 50. Further, it will be understood that the branch 54 may include a plurality of components (e.g., linear sections, coupling portions, elbows, etc.) without departing from the teachings provided herein. The branch 54 may have one outlet 62 or a plurality of outlets 62. In home and commercial uses, the outlet 62 may include a sink, toilet, clothes washing machine, dishwashing machine, faucet, sprinkler system, vent and/or other outlets which may release the fluid within branch 54. It will be understood that the branch 54 and/or the outlet 62 may also be part of a heating or cooling system for the structure housing the fluid system 14.

The detector 18 is configured to couple to the fluid system 14 at a variety of locations. For example, the detector 18 may be coupled to the main line 50, the branch 54 and/or the outlet 62. According to various examples, the plumbing detection system 10 may include a plurality of detectors 18 at one or in a plurality of locations of the fluid system 14. The detector 18 may be positioned externally to the components of the fluid system 14 (e.g., coupled to the exterior of a pipe), internally to the components of the fluid system 14 (i.e., in contact with the fluid) and/or integrated into one or more components of the fluid system 14. The detector 18 may be configured to detect one or more properties of the fluid system 14 or structure proximate thereto. For example, the detector 18 may be a temperature sensor, a fluid level detector (e.g., for a sump pump), a sensor configured to detect one or more properties (e.g., direction, speed, flow volume, phase, etc.) of the fluid in the fluid system 14, or different type of sensor (e.g., moisture sensor) positioned within the structure supporting the fluid system 14. In some embodiments, the processor of the fluid system may determine that there has been a phase change, such as a fluid freezing, in the fluid in the fluid system 14. If there has been a phase change, the detector may be configured to cause a signal to be transmitted to an external receiver.

In some embodiments, the detector 18 may be in communication with the turbine 26, and may be configured to detect fluid movement based on turbine movement. The detector 18 may use electrical energy to operate with the electrical energy being drawn from the electrical storage 34. In other words, one or more of the detectors 18 may be directly electrically coupled to the electrical storage 34.

One or more of the detectors 18 may be electrically coupled to the transmitter 38. For example, one or more of the detectors 18 may have the transmitter 38 integrated therein, or an electrical connection may extend between them. The transmitter 38 may be a wired or wireless transmitter 38. The transmitter 38 may be in communication with and configured to send signals between any one of the detectors 18, a home automation system 70, an external receiver 74 and/or other receiver. In wireless examples of the transmitter 38, the transmitter 38 may utilize Bluetooth®, WiFi™, radio frequency communication and/or combinations thereof. The transmitter 38 is configured to send one or more signals related to information or properties detected by the detector 18 as explained in greater detail below. In other words, the transmitter 38 may be configured to emit a signal from the detector 18. It will be understood that the transmitter 38 may be a transceiver such that the transmitter 38 may send and/or receive signals.

As explained above, the power section 22 of the plumbing monitoring system 10 includes the turbine 26 and the generator 30. The power section 22 may include a housing 80 defining a cavity 84 which is integrated into the fluid system 14. For example, the housing 80 may be a pipe or tube configured to allow the fluid of the fluid system 14 to flow through the cavity 84. The housing 80 of the power section 22 may have a smaller, larger or the same size internal diameter as the component of the fluid system 14 the housing 80 is coupled to. The fluid may flow in a single direction or in multiple directions through the housing 80.

According to various examples, the turbine 26 is positioned within the cavity 84 of the housing 80. The turbine 26 may include a plurality of blades 88 positioned on a drum 92 allowing the blades 88 to rotate. As the fluid of the fluid system 14 flows through the cavity 84 of the housing 80, the impact of the fluid on the blades 88 of the turbine 26 may cause the turbine 26 to move. The movement of the turbine 26 may be an oscillation, a spinning, a rotating, a cyclic movement, a noncyclic movement or any other type of movement. The drum 92 is coupled to the generator 30 such that the rotating or spinning energy of the turbine 26 is transmitted to the generator 30. According to various examples, the amount of movement of the turbine 26 may be used to infer the amount of fluid passing over the turbine 26. For example, as the amount of movement of the turbine 26 is proportional to the amount of fluid passing over the turbine 26, the relative amount of fluid may be determined. It will be understood that such information of the amount of fluid passing over the turbine 26 may be used or transmitted by the plumbing monitoring system 10.

In the depicted example, the generator 30 is positioned within the cavity 84 of the housing 80, but it will be understood that the generator 30 may be positioned externally to the housing 80. For example, the generator 30 may be positioned proximate the fluid system 14 or externally therefrom. In yet other examples, the turbine 26 and the generator 30 may be integrated into a single component (i.e., with or without the drum 92 to support the blades 88). The generator 30 may include one or more structures (e.g., metallic windings and magnets) configured to convert the mechanical spinning or rotating motion of the turbine 26 (i.e., due to the fluid contacting the blades 88) into electrical energy.

The electrical energy generated by the generator 30 may be supplied directly or indirectly to the detector 18, the transmitter 38, the electrical storage 34 and/or other electrical components of the fluid system 14 or plumbing monitoring system 10. The electrical energy generated by the generator 30 may be sufficient to power the detector 18, power the transmitter 38 and/or to recharge the electrical storage 34. It will be understood that electrical energy may be supplied to the transmitter 38 and the detector 18 from the electrical storage 34 which is recharged by the generator 30 as needed. In some embodiments, for example, when the transmitter 38 is transmitting a long signal (e.g., a large amount of data from the detector 18), the transmitter 38 may be configured to emit the signal while the turbine 26 is spinning such that sufficient energy is generated to complete the signal. If a large amount of data needs to be transmitted, the data may be stored (e.g., in a data storage unit of the plumbing monitoring system 10) until fluid is moving in the fluid system 14 to spin the turbine 26 at which time the data may be transmitted by the transmitter 38.

The electrical storage 34 is configured to store a sufficient amount of electrical energy to power the detector 18 and/or transmitter 38 for an extended period of time. For example, as the fluid may not always be flowing in the fluid system 14, the electrical storage 34 must need to be able to provide sufficient electrical charge with only intermittent recharging from the generator 30. The electrical storage 34 may include a battery, a plurality of batteries, a capacitor, other systems configured to store electrical energy and/or combinations thereof. As the generator 30 is configured to provide electrical energy to the electrical storage 34, the electrical storage 34 may be rechargeable.

In operation, the plumbing monitoring system 10 may be configured to allow prolonged use of the detector 18. For example, a user of the system 10 may place one or more of the detectors 18 proximate the fluid system 14. As explained above, the detector(s) 18 may be configured to detect one or more properties of the fluid within the fluid system 14 and/or a property of the structure holding the fluid system 14. As the detector 18 is used, electrical energy of the electrical storage 34 may become slowly depleted. The electrical energy of the electrical storage 34 may be replenished as fluid of the fluid system 14 passes through the housing 80 and turns the turbine 26. According to various examples, particularly power heavy usages (e.g., data transmission by the transmitter 38) may be reserved for periods of time while the turbine 26 is turning. The detected information from the detector 18 may be transmitted to the home automation system 70 for further data processing. In yet other examples, the transmitter 38 may transmit data to the external receiver 74 which may be a cell phone tower, other radio receiver, an external server or the like. Further, the transmitter 38 may send an alert to the home automation system 70 and/or external receiver 74 if the electrical charge of the electrical storage 34 drops below a predetermined value. Even further, if the electrical storage 34 has an electrical charge which drops below a predetermined value, the transmitter 38 may send a signal to another component of the plumbing monitoring system 10 and/or the fluid system 14 to open a valve such that fluid flows across the turbine 26 to charge the electrical storage 34.

Use of the present disclosure may offer a variety of advantages. For example, by providing a renewable power source to detectors 18 which may be placed in inconvenient or infrequently checked areas, the plumbing monitoring system 10 may be utilized for an extended period of time as compared to conventional systems. Further, as the plumbing monitoring system 10 offers a method to recharge its electrical storage 34, the likelihood of the detector 18 being deprived of electrical energy to run and inadvertently not alerting a user to the intended parameter of the fluid system 14 may be reduced. Another advantage potentially offered by the plumbing monitoring system 10 is that the system 10 may be used in a location where power is unavailable. For example, as the power section 22 is configured to produce electrical energy with the generator 30, fluid systems 14 away from power sources (i.e., outdoors or in buildings with the power turned off) may be monitored.

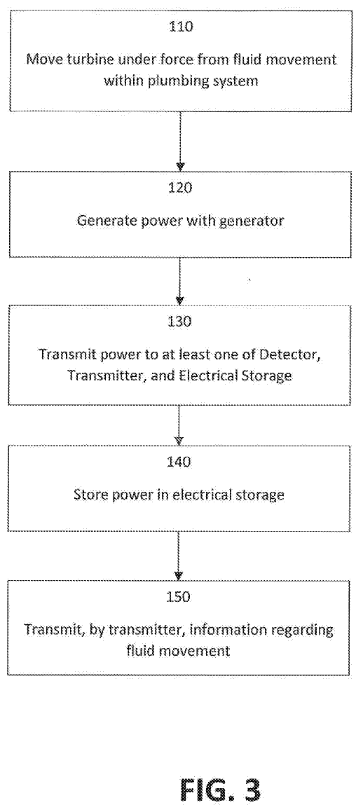

A method for detecting leaks in a plumbing system, shown in FIG. 3, may comprise moving the turbine 26 under force, the force exerted by the movement of the fluid within the plumbing system, to generate power, shown at step 110. In step 120, the generator 30 may generate power in response to the movement of the turbine 26. In step 130, power may be transmitted from the generator 30 to at least one of the electrical transmitter 38, the detector 18, and the electrical storage 34. In step 140, electrical power may be stored by electrical storage 34. In step 150 information may be transmitted by transmitter 38. The information may include data on the fluid movement within the plumbing system. The information may be transmitted to at least one of a home automation system 70 an external receiver 74, and another receiver.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and, further, it is to be understood that such concepts are intended to be covered by the following claims, unless these claims, by their language, expressly state otherwise.

What is claimed is:

1. A plumbing monitoring system, comprising:
a detector configured to be coupled to a fluid system;
a power section configured to be in electrical communication with the detector, comprising:
a turbine configured to move under force from a movement of fluid of the fluid system; and
a generator coupled to the turbine and configured to generate electrical energy from the movement of the turbine; and
an electrical storage in electrical communication with and configured to provide electrical power to the detector.

2. The plumbing monitoring system of claim 1, wherein the electrical storage is rechargeable.

3. The plumbing monitoring system of claim 1, wherein the generator is electrically coupled to the electrical storage.

4. The plumbing monitoring system of claim 1, wherein the detector is a fluid level detector.

5. The plumbing monitoring system of claim 1, further comprising:
a transmitter configured to transmit a signal from the detector.

6. The plumbing monitoring system of claim 5, wherein the transmitter is a wireless transmitter.

7. The plumbing monitoring system of claim 5, wherein the transmitter is configured to emit the signal while the turbine is moving.

8. The plumbing monitoring system of claim 5, wherein the electrical storage is electrically coupled to the transmitter.

9. The plumbing monitoring system of claim 1, wherein the detector is a temperature sensor.

10. The plumbing monitoring system of claim 1, wherein the fluid is water.

11. The plumbing monitoring system of claim 1, wherein the fluid system is a plumbing system.

12. A plumbing monitoring system, comprising:
a detector configured to be coupled to a fluid system comprising; and
a power section configured to be coupled to the fluid system, comprising:
a turbine configured to move under force from the fluid of the fluid system; and
a generator coupled to the turbine and configured to generate electrical energy from the moving turbine.

13. A method for detecting leaks in a plumbing system, comprising:
moving a turbine under force from fluid movement within the plumbing system;
generating electric power with a generator in communication with the turbine;
transmitting power to at least one of a detector, a transmitter, and an electrical storage;
and
storing power in the electrical storage.

14. The method of claim 13, further comprising transmitting, by the transmitter, information on fluid movement.

15. The method of claim 14, wherein the information on fluid movement is transmitted to at least one of a home automation system and an external receiver.

16. The method of claim 13, wherein an electrical storage is rechargeable.

17. The method of claim 13, wherein the fluid detector is a fluid level detector.

18. The method of claim 18, wherein the fluid detector is a sensor configured to detect at least one property of the fluid in the plumbing system.

19. The method of claim 18, wherein the fluid detector is a temperature sensor.

20. The method of claim 13, wherein the electrical storage is in electrical communication with at least one of the detector, the transmitter, and the electrical storage.
